(19) United States
(12) Patent Application Publication
(10) Pub. No.: US 2023/0316602 A1
(43) Pub. Date: Oct. 5, 2023

(54) METHOD FOR CORRECTING ARTIFACTS IN A COMPUTED TOMOGRAPHY IMAGE DATA SET, COMPUTED TOMOGRAPHY FACILITY, COMPUTER PROGRAM AND ELECTRONICALLY READABLE DATA CARRIER

(71) Applicant: Siemens Healthcare GmbH, Erlangen (DE)

(72) Inventors: Bernhard SCHMIDT, Fuerth (DE); Christian CANSTEIN, Nuernberg (DE)

(73) Assignee: Siemens Healthcare GmbH, Erlangen (DE)

(21) Appl. No.: 18/191,110

(22) Filed: Mar. 28, 2023

(30) Foreign Application Priority Data
Mar. 30, 2022 (DE) 10 2022 203 101.6

(51) Int. Cl. G06T 11/00; G06T 7/00

(52) U.S. Cl. CPC G06T 11/008; G06T 7/0012; G06T 2210/41; G06T 2211/40; G06T 2207/10081; G06T 2207/20224; G06T 2207/20081; G06T 2207/30004

(57) ABSTRACT

For a computed tomography image data set of a recording region in which an at least substantially needle-shaped metal object is located, a method for correcting artifacts comprises: ascertaining an artifact data set describing, in an image space, at least one artifact caused by the at least substantially needle-shaped metal object, wherein the ascertaining uses prior knowledge about the at least one artifact; and subtracting the artifact data set from the computed tomography image data set. The computed tomography image data set being reconstructed from projection images, which are recorded at least partially such that the at least substantially needle-shaped metal object is irradiated at least substantially in the longitudinal direction.

### CROSS-REFERENCE TO RELATED APPLICATION(S)

The present application claims priority under 35 U.S.C. § 119 to German Patent Application No. 10 2022 203 101.6, filed Mar. 30, 2022, the entire contents of which are incorporated herein by reference.

### FIELD

One or more example embodiments of the present invention relate to a method for correcting artifacts in a computed tomography image data set of a recording region, in which an at least substantially needle-shaped metal object is located, wherein the computed tomography image data set is reconstructed from projection images, which are recorded at least partially in such a manner that the metal object is irradiated at least substantially in the longitudinal direction. In addition, one or more example embodiments of the present invention relate to a computed tomography facility or device, a computer program and an electronically readable data carrier.

### BACKGROUND

Lower-dimensional projection images, for example one- or two-dimensional projection images of a recording region, are used in computed tomography in order to ascertain a higher-dimensional computed tomography image data set, in particular two- or three-dimensional, respectively, which describes attenuation values in the irradiated recording region. In this context, very strongly attenuating objects, in particular metal objects, in the beam path of the computed tomography facility represent problems in particular, as these may cause what are known as metal artifacts in the reconstructed computed tomography image data set. This may impair the diagnosis in the medical region. In this context, artifacts and corresponding corrective measures are known in particular for hip replacements, dental inlays or dental crowns.

The use of computed tomography imaging in particular also during the monitoring of operative interventions, in particular minimally invasive interventions, has already been proposed. In this context, partially elongated metal objects, for example intervention needles, are used as intervention instruments. In this context, the person performing the intervention, for example a physician, usually desires a representation which monitors the intervention in the plane in which the intervention instrument also lies with its longitudinal direction. For example, it is consequently possible for one or more two-dimensional sectional images to be ascertained as the computed tomography image data set, in which what lies in the intervention region ahead of the intervention instrument, in particular the intervention needle, is to be identified as precisely as possible.

This means that in interventions of this kind the projection directions are usually chosen in such a longitudinal extension plane of the metal object that the metal is irradiated at least substantially in the longitudinal direction in some of the projection images. This means that some few projection images, namely those at least substantially along the longitudinal axis of the metal object, experience an extremely strong attenuation due to the metal object, which leads to artifacts in the reconstruction result, which generally are sharply delimited and run into the tissue starting from the metal object tip, in particular the needle tip. In this context, for example, this may involve a region of 1 to 4 cm ahead of the metal object.

Thus, completely different circumstances are present in such imaging conditions, in particular during the monitoring of interventions with intervention needles, than for metal artifacts in general. This is because, in the case of the intervention monitoring of an intervention with an intervention needle or a comparable elongated metal object, the artifacts are caused less by the intensity of the attenuation of the material itself, but rather instead by the irradiated length along the longitudinal axis of the metal object, in particular the intervention needle. Thus, an intervention instrument of this kind may have a length of 15 to 20 cm, for example. If the X-ray radiation does not progress along the longitudinal direction, which is the case in approximately 99% of projections or individual X-ray beams, however, then only little metal is irradiated and the measured signal can be used meaningfully for reconstruction.

In the prior art, it has already been proposed in this regard to minimize the artifacts caused by elongated metal objects, in particular intervention needles, by way of metal artifact reduction algorithms. This is not always successful and moreover is computing-intensive, which is problematic in that, in minimally invasive interventions with image monitoring, the person performing the intervention generally would like to see a representation of the intervention area in real time. Complex correction algorithms incorporating the raw data are an obstacle to this. When using interpolation techniques for eliminating the metal artifacts, there is also the problem that specifically in the most important region, namely next to the tip of the metal object, it is possible for actual structure to be lost, which structure however is extremely important for the intervention and the further progression.

In addition to the methods mentioned for raw data-based metal artifact reduction, it has also been proposed to tilt the gantry of the computed tomography facility, and thus avoid the irradiation along the longitudinal axis. However, persons performing interventions prefer to guide intervention instruments in parallel with the recording plane of the computed tomography facility, as the intervention instrument, in particular the intervention needle, and the anatomical feature to be treated, for example a lesion to be punctured, are then recorded in a single computed tomography image data set and can be represented in particular in one sectional image.

### SUMMARY

An object underlying one or more example embodiments of the present invention is to specify a mechanism, means and/or manner, which is improved, real-time-capable and suitable for interventions with elongated metal objects, in particular intervention needles, for correcting artifacts caused by the elongated metal object.

To achieve at least this object, a method, a computed tomography facility (also referred to as a computed tomography device), a computer program and/or an electronically readable data carrier are provided according to one or more example embodiments of the present invention and/or according to the claims. Advantageous embodiments will become apparent from the detailed description and/or dependent claims.

In a method of the kind mentioned in the introduction, the following steps are provided according to an example embodiment of the present invention:
ascertaining an artifact data set, which describes at least one artifact caused by the metal object and uses (and/or is based on) prior knowledge about the artifact, in the image space, and
subtracting the artifact data set from the reconstructed computed tomography image data set.

According to an example embodiment of the present invention, it is consequently proposed to use prior knowledge about the appearance of the artifact in the image space, in order to ascertain an artifact data set particularly rapidly, in particular in real time, and in a less complicated manner, which can be subtracted from the reconstructed computed tomography image data set in the image space and only relates to the artifact caused by the metal object, meaning that underlying structures in the recording region, in particular in the intervention region directly ahead of the tip of the metal artifact, can be maintained in the signal progression, as only the artifact components are removed. In the case of elongated metal objects that are irradiated at least partially longitudinally during the recording of the projection images, typical artifacts appear starting from the tip of the metal object in the form of dimmed areas, consequently lower attenuation values, usually HU values (HU=Hounsfield Units). The HU dimmed areas relate to anatomically relevant structures, but likewise—specifically to the same extent—to the surrounding area with anatomically relevant structures, for example a lesion. One or more example embodiments of the present invention are now based on the idea of exploiting the fact that the shape, intensity and manifestation of the dimmed areas, i.e. of the artifact, are simple to identify. In particular it involves a low-frequency signal, which always originates at the tip of the metal object and the intensity of which, i.e. the degree of the dimming, decreases as the distance from the tip of the metal object increases. In particular, it may also specifically be provided that the artifact data set is ascertained in such a manner that the artifact that starts at the tip of the metal object and in particular expands at an angle is assigned an attenuation value that rises with increasing distance from the tip to zero toward its edges. This is because dimmed areas in the HU value, which signal the artifact, are represented by an increase in the image signal, i.e. correction values to be subtracted negatively.

Consequently, the formulation of the present invention of course also comprises the case in which the artifact data set describes an artifact intensity, which can then be added to the reconstructed computed tomography image data set, as the artifact intensity merely represents the negative of the attenuation values of the artifact data set to be subtracted.

This approach—correction of dimmed areas in the image space—has the significant advantage that the structure is preserved in the correction region of the artifact. This is because, despite the dimmed areas that occur due to the artifact, the contrast of anatomical features in the reconstructed computed tomography image data set is preserved in principle, wherein in the presence of the artifact, however, the entire region affected by the artifact has a lower HU value compared to the rest of the computed tomography image data set, and thus is generally more difficult to diagnose. Merely by removing the aforementioned low-frequency artifact signal from the computed tomography image data set again, the anatomical structures and their surrounding area, in particular a lesion, lie in the “correct” attenuation value range and due to the improved ability to identify the metal object and the anatomical structures, in particular the lesion, the person performing the intervention is able to successfully perform the minimally invasive intervention or generally correctly assess, in particular diagnose, the corrected reconstructed computed tomography image data set.

Thus the proposed solution allows a rapid, image-based correction of the artifacts, wherein a tilting of the beam plane is not necessary. Compared with classic methods for metal artifact reduction, there is also the advantage that no values have to be replaced in the projection data, but rather only the attenuation value level has to be raised or corrected. Thus, anatomical structures are more effectively preserved in the artifact region.

In this context, during intervention monitoring with the metal object as intervention instrument, in particular intervention needle, the correction can take place, in particular in real time, for each recorded computed tomography image data set of a corresponding monitoring series. In general it is expedient, specifically in the context of such an intervention monitoring, if the image plane of the, in particular two-dimensional, computed tomography image data set (or of a two-dimensional sectional image comprised thereby) is a longitudinal extension plane of the metal object. In this manner, the person performing the intervention can be shown all relevant information in a single image.

In this context, various approaches are conceivable in principle for ascertaining the artifact data set on the basis of the prior knowledge. For example, in principle analytical derivations are possible as a basis; particularly preferred approaches, however, relate to the use of an as small as possible component of image data from the computed tomography image data set together with predefined progressions or learning on the basis of previously performed measurements. In this context, as part of the present invention, in principle artificial intelligence approaches are of course also conceivable, yet it has been shown that these are not absolutely necessary, as a corresponding derivation of the artifact data set can take place with less complexity on the basis of prior knowledge.

Thus, a first, particularly preferred specific embodiment of the present invention provides that the artifact data set is ascertained at least partially by ascertaining and/or adapting at least one progression function, which describes the progression of the artifact that starts from the tip of the metal object in at least one direction in the image space, on the basis of image data, lying in the artifact region, of the reconstructed computed tomography image data set. In this context, in this embodiment, the prior knowledge can be included in the choice of the functional form of the at least one progression function or the parametrization thereof. In particular, it is conceivable when fitting image data or information derived therefrom to the at least one progression function to predefine boundary conditions, which considerably simplify the search for an optimum fit. Furthermore, certain progressions resulting from the prior knowledge can be rendered efficiently as a progression function with only a few parameters, for example 2 to 15, wherein corresponding specific options are presented in the following.

In this context, expediently the entirety of the image data is not used in the artifact region, but rather due to the prior knowledge it is also possible here to reduce the image data necessary for ascertaining the artifact data set. It may specifically be provided that the image data to be used for adapting and/or ascertaining the at least one progression function is ascertained at least partially on the basis of a user input and/or on the basis of an automatically ascertained image evaluation result, in particular a segmentation of the metal object. In this context, in particular on the basis of the prior knowledge used, embodiments are conceivable in which image data of an artifact origin (adjacent to the tip of the metal object) and of a few selection lines in the artifact region transverse to the longitudinal direction, for example one or two selection lines, are already sufficient in order to ascertain an artifact data set with sufficient quality for the high-quality correction of the reconstructed computed tomography image data set.

Expediently, at least one of the at least one progression function can be a transverse progression function perpendicular to the longitudinal direction of the metal object in a longitudinal extension plane, in particular corresponding to the image plane of the computed tomography image data set, of the metal object, wherein the image data is chosen along at least one selection line that progresses at least substantially perpendicularly to the longitudinal direction of the metal object. The at least one selection line in the computed tomography image data set lies ahead of the metal object, in particular at a distance from the tip thereof. In this context, it has been established that the artifact triggered by the metal object shows as a kind of “bump” in the HU value progression in the transverse direction, which is possibly also overlaid by anatomical structures. It is therefore expedient to choose the at least one selection line automatically and/or manually such that as few anatomical structures as possible, for example edges, are present along it.

Particularly advantageously, in this context, a Gaussian function can be chosen as the transverse progression function or the functional form thereof. Examinations of artifacts of elongated metal objects, in particular of intervention needles, have shown that a Gaussian function most accurately describes the progression of the attenuation value drop in the transverse direction. A Gaussian function is parametrized via few parameters, meaning that a rapid and simple fit procedure can be achieved, in order to adapt the Gaussian function as a transverse progression function to the image data along the selection line. In principle, however, other approaches are also conceivable, for example the description on the basis of a half cycle of a sine function.

More generally, it can also be said that a functional form of the transverse progression function to be adapted and/or to be ascertained is chosen from the prior knowledge about the artifact, which in particular is specific to the metal object, wherein what is stated in the following regarding the longitudinal progression function applies accordingly.

In a particularly advantageous manner, a longitudinal progression function along the longitudinal direction of the metal object can be used as a further progression function, wherein the longitudinal progression function describes at least one parameter of a functional form chosen as the transverse progression function, in particular the Gaussian function, along the longitudinal direction. Consequently, for example, a parametrization for the transverse progression function, for example the Gaussian function, can initially be ascertained for at least one selection line, from which the longitudinal progression function is inferred through the use of at least one further supporting point, as will be explained in further detail below. Then, via the transverse progression function and the longitudinal progression function, which may relate to different parameters, the artifact progressions are fully known, meaning that the artifact data set can be ascertained in a simple manner, in the specific, preferred exemplary embodiment as successive Gaussian functions in the longitudinal direction starting from the tip of the metal object or generally transverse progression functions that are parametrized in accordance with the ascertained longitudinal progression function.

In this context, an expedient development provides that, for the ascertaining and/or adapting of the longitudinal progression function, image data of at least one image point, which lies adjacent to the tip of the metal object as the artifact origin, of the artifact is chosen in the reconstructed computed tomography image data set. In this manner, a starting point, so to speak, at which the artifact originates with the maximum dimming, is known, which in particular can be directly used for adapting or choosing a parameter of the longitudinal progression function, for example an amplitude of the Gaussian function at the artifact origin. In particular, it has been shown that using the artifact origin image point as well as a selection line may already be sufficient, in order to ascertain or adapt, on the basis of these supporting points, a longitudinal progression function which is capable of providing an artifact data set which corrects in an excellent manner. In this context, it should be noted in particular that the first 1 to 2 cm ahead of the tip of the metal object during the intervention monitoring represents the significant region, in which the artifacts are to be determined sufficiently precisely so that structures, for example a targeted lesion, can be assessed. Deviations in regions at greater distances are therefore less relevant. By way of example, it is therefore conceivable to choose the or at least one of the selection lines in a region of 1 to 2 cm ahead of the tip of the metal object. It should be noted that, in particular during a desired more precise determination of the longitudinal progression function, it may be expedient to use a plurality of selection lines, for example two or three selection lines.

Specifically, it may be provided that a functional form of the longitudinal progression function to be adapted and/or to be ascertained is chosen from the prior knowledge about the artifact, which in particular is specific to the metal object. In a simple case, it may be conceivable for example to choose a linear function as the longitudinal progression function; other longitudinal progression functions for the amplitude, which rise monotonically in the artifact region to an attenuation value of zero, can likewise be used, as can corresponding longitudinal progression functions for mapping with regard to the artifact width, for example the width of the Gaussian function, and the like.

In this context, but also with regard to the determination of a functional form of the transverse progression function, it may expediently be provided that, to ascertain the prior knowledge, analytical calculations of the artifact and/or preferably calibration measurements of the metal object and/or a metal object of the same type are performed in an, in particular structureless, phantom, in particular a water phantom. In this context, calibration measurements that relate to a structureless phantom, for example a water phantom, have proven to be particularly advantageous for training the progression, as ultimately the single structure ahead of the tip of the metal object is given by the artifact. Consequently, the artifact progression of the calibration measurements can be “read off” in a simple manner, meaning that for the same metal object the shape can easily be determined for example by averaging over a plurality of calibration measurements, and for example a fitting of a functional form thereto can take place. Particularly preferably, a spline interpolation can take place here, in order to determine a functional form for the longitudinal progression function. From such calibration measurements, it is also possible to track the preferred choice of a Gaussian function for the transverse progression function in a particularly simple and effective manner.

In another, advantageous approach, it may be provided that the artifact data set is chosen and/or determined at least partially from reference data sets present in a database for various reference metal objects and/or various parameters of the metal object and/or the reference metal objects. Since the number of elongated metal objects used as intervention elements, in particular intervention needles, is finite and, given that they are of the same type, the same artifacts are to be anticipated, as part of the present invention it is also possible to use a database, from which, when the elongated metal object is known, the corresponding reference data set can be used. In this context, it can preferably be provided that the reference data sets are derived from learning measurements of the metal object and/or at least one reference metal object of the same type in an, in particular structureless, phantom, in particular a water phantom. As already stated in relation to the longitudinal progression function, structureless phantoms, in particular water phantoms, are particularly suitable for reference measurements as well as calibration measurements, as ultimately the artifact is produced there as a single structure, if the metal object or reference metal object is introduced into the phantom, wherein it is also clearly known which HU value would be anticipated without the artifact. Accordingly, it is possible to perform measurements for a wide variety of metal objects, in particular reference metal objects, or many different parameters of the same, and to derive the reference data sets, which can be used as artifact data sets or can be used for the determination thereof. In this context, statistical methods are particularly preferably used to increase the data quality. Alternatively, but less preferably, it is also conceivable to perform analytical calculations, in order to ascertain the reference data sets.

In this context, interpolations and/or extrapolations are otherwise also conceivable, if for example a parameter of a metal object actually used lies between or outside of parameters for which reference data sets are present in the database.

If recording parameters for the projection images, from which the computed tomography image data set is reconstructed, were to deviate from the recording parameters that were used for the reference data sets, then an expedient development of the present invention may provide that these deviations are taken into consideration during the at least partial ascertaining of the artifact data set via the database. In this context, for recording parameters which influence the image result, it is already known how corresponding conversions may take place.

In addition to the method, one or more example embodiments of the present invention also relate to a computed tomography facility (or device) having a control facility (or device) embodied for performing the method according to one or more example embodiments of the present invention. All the statements relating to the method according to example embodiments of the present invention can be applied analogously to the computed tomography facility according to example embodiments of the present invention, and therefore the advantages mentioned thus can also be obtained therewith. In this context, the computed tomography facility in particular may also involve an interventional C-arm facility, which likewise makes it possible to record projection images from various projection directions, consequently allowing computed tomography.

Since the correction in relation to the artifacts is preferably to take place in real time at the location of an, in particular minimally invasive, medical intervention, which is allowed by the procedure according to one or more example embodiments of the present invention, in particular the control facility of the respective computed tomography facility is directly embodied to perform the method according to one or more example embodiments of the present invention, meaning that the corrected computed tomography image data set can be directly output on a display facility (or device) of the computed tomography facility at the intervention location. The control facility can comprise at least one processor and at least one storage means or device, such as a memory, in which in particular the prior knowledge can be stored. In order to implement the method according to one or more example embodiments of the present invention, the computed tomography facility can comprise an ascertaining unit for ascertaining the artifact data set and a correction unit for using the artifact data set for correction, in particular for subtraction. Of course, with regard to embodiments of the method according to the present invention, further functional units or functional subunits may also be accordingly provided.

A computer program according to one or more example embodiments of the present invention can be loaded directly into a computing facility, in particular a control facility of a computed tomography facility, and has program means and/or instructions for performing the steps of the method according to one or more example embodiments of the present invention when the computer program is executed on the computing facility, in particular the control facility. The computer program may be stored on an electronically readable data carrier according to one or more example embodiments of the present invention, which therefore comprises control information which comprises at least one computer program according to one or more example embodiments of the present invention and, when the data carrier is used in a computing facility, in particular a control facility of a computed tomography facility, configure it to perform the method according to one or more example embodiments of the present invention. The data carrier can involve, in particular, a non-transient data carrier or non-transitory computer-readable storage medium, for example a CD-ROM.

### BRIEF DESCRIPTION OF THE DRAWINGS

Further advantages and details of the present invention are disclosed in the exemplary embodiments described below and by reference to the drawing, in which:

FIG. 1 shows a real situation in a recording region,

FIG. 2 shows the situation during ideal imaging without artifacts,

FIG. 3 schematically shows a real imaging result,

FIG. 4 shows an attenuation value progression in the transverse direction,

FIG. 5 shows an attenuation value progression in the longitudinal direction,

FIG. 6 shows a flow diagram of an exemplary embodiment of the method according to the present invention,

FIG. 7 shows a computed tomography facility according to an exemplary embodiment of the present invention, and

FIG. 8 shows the functional structure of a control facility of the computed tomography facility.

### DETAILED DESCRIPTION

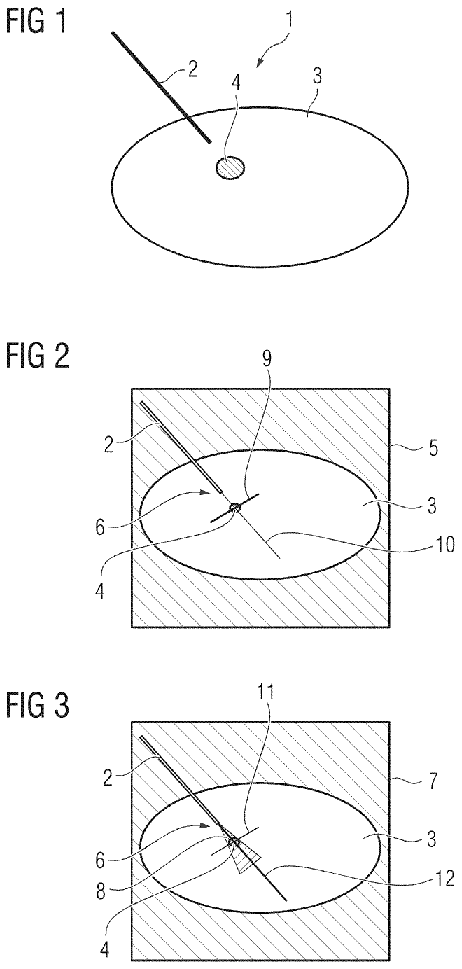

FIG. 1 schematically shows a situation in which an elongated metal object 1, here an intervention needle 2, is introduced into an object 3, here as part of a medical intervention into the body of a patient, wherein the object 3 has an X-ray-relevant structuring, for which by way of example a target structure 4, here a lesion, which is to be reached by the metal object 1, for example punctured by the intervention needle 2, is shown. At this point, however, it should be noted that the method is not restricted to interventions on a patient, but rather of course can also be used in other situations, for example in manufacturing or general processing procedures, in which an intervention on an object 3 is to take place via an elongated metal object 1, specifically during image monitoring. In the present case, the image monitoring takes place by way of computed tomography, wherein in the present case a rotation of the recording arrangement takes place in the plane of metal object 1 and target structure 4, meaning that some of the X-ray beams fully or at least largely cross the longitudinal extension of the metal object 1, consequently with an extremely strong attenuation occurring for extremely few projection images. This manifests itself in the reconstructed computed tomography image data set as an artifact, which is to be explained in further detail with regard to FIG. 2 and FIG. 3.

In this context, FIG. 2 schematically shows an ideal two-dimensional sectional image 5 of a computed tomography image data set, in which the object 3 can be clearly identified with the target structure 4 ahead of the tip 6 of the intervention needle 2, which is shown as bright, in front of a black background (no attenuation).

FIG. 3 shows the real situation in the form of a corresponding sectional image 7 of the reconstructed computed tomography image data set. Evidently, due to the artifact 8 originating at the tip 6 of the intervention needle 2, the target structure 4 can hardly be seen. The artifact 8 shows in the form of HU dimmed areas and represents a low-frequency signal, which always originates at the needle tip 6 and decreases in intensity as the distance from the needle tip 6 increases.

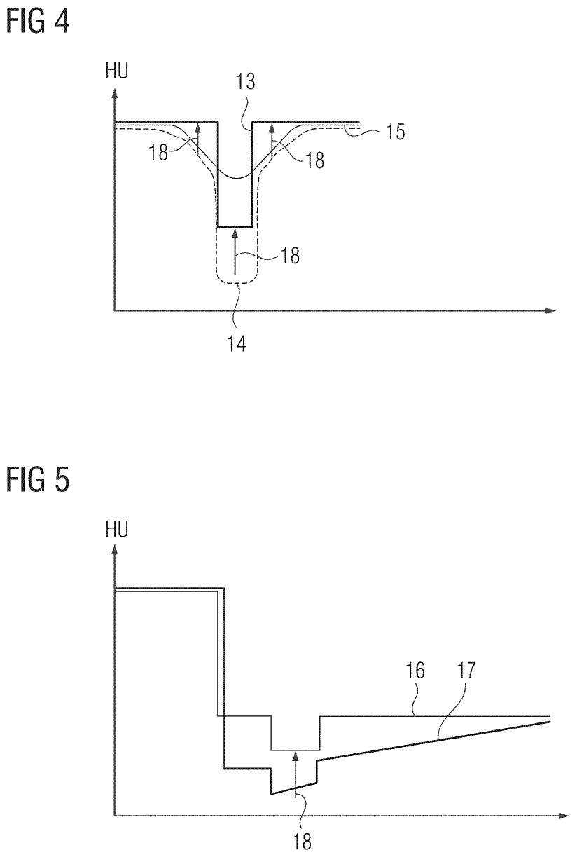

In order to explain this and the basic idea of the present invention in further detail, profile lines 9, 10, 11, 12 are shown in the transverse direction and in the longitudinal direction of the elongated metal object 1 in FIG. 2 and FIG. 3, wherein the attenuation value progression is schematically shown along the transverse lines in FIG. 4, and along the longitudinal lines in FIG. 5.

In FIG. 4, the progression 13 corresponds to that along the line 9 and the progression 14 corresponds to that along the line 11. Evidently, the progression 14 can be described as a superimposition of the progression 13 with a transverse progression 15 which describes the artifact. In this context, it can already be seen in FIG. 4 that the progression 15 can be very effectively mapped by a Gaussian function.

Accordingly, in FIG. 5 the progression 16 corresponds to the profile line 10, and the progression 17 corresponds to the profile line 12. Here too, it can be clearly seen that merely a reduction of the HU values is given by a longitudinal progression of the artifact 8 (which is not shown in further detail in FIG. 5 for clarity reasons).

Accordingly, the idea is now to correct the reconstructed computed tomography image data set, schematically indicated by the sectional image 7, in the direction of the ideal sectional image 5, by the artifact components being removed again to the greatest possible extent by raising the attenuation values, cf. arrow 18.

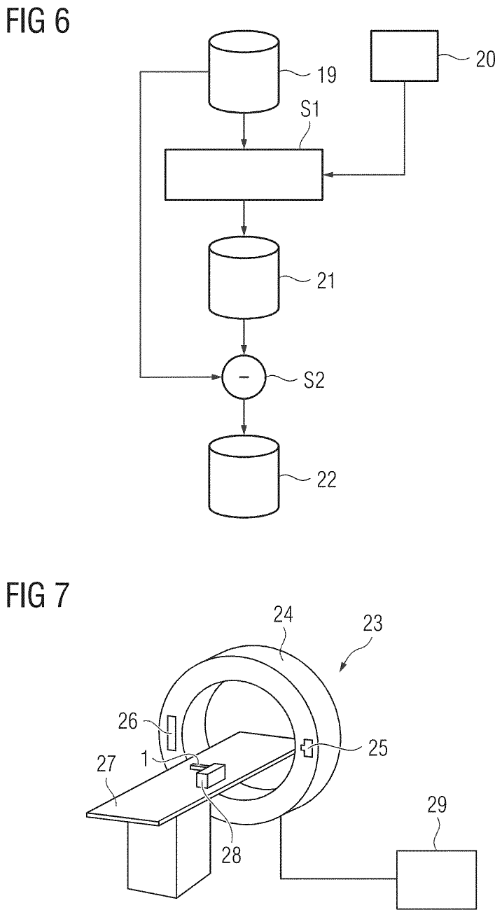

FIG. 6 shows the progression of a corresponding method according to an example embodiment of the present invention in the form of a flow diagram. Here, firstly the reconstructed computed tomography image data set 19 is provided. Using the computed tomography image data set 19 and prior knowledge 20 about the artifact 8, an artifact data set 21 describing the artifact 8 in the image space is described in a step S1. In a step S2, this can then be subtracted from the reconstructed computed tomography image data set 19, in order to obtain a corrected computed tomography image data set 22.

The artifact data set 21 consequently ultimately describes the transverse progression 15 in accordance with FIG. 4 as well as the corresponding longitudinal progression for FIG. 5, not shown in further detail for the sake of clarity, meaning that the step S2 corresponds to the operation indicated by the arrow 18.

In this context, two preferred approaches exist for enabling a specific implementation of the ascertaining of the artifact data set 21 in step S1. The first approach is substantially oriented toward what is shown in FIG. 4 and FIG. 5, and uses progression functions derived from the prior knowledge 20, specifically predefined progression forms, in order to allow a more rapid fitting on the basis of less image data of the reconstructed computed tomography image data set 19. This proceeds as follows in a particularly preferred exemplary embodiment.

In a first substep of step S1, the image data is selected, which forms the basis of the ascertaining of the progression functions. In this context, the selection can take place at least partially automatically and/or at least partially manually, for example by user marking. An automatic marking can be based, for example, on a segmentation of the metal object 1 in the reconstructed computed tomography image data set 19. In the present case, the following are selected as image data: image data of an image point, which marks the artifact origin adjacent to the tip 6 of the metal object 1, and image data along at least one selection line, which is transverse to the longitudinal direction marked by the profile lines 10 and 12 in the image plane, i.e. in parallel with the profile lines 9 and 11. For the selection line, in this context a less structured region of the object 3 is ideally used, therefore in the example ideally processed outside the target structure 4. Ideally, at least one of the at least one selection line is located 1 to 2 cm away from the tip 6 of the metal object 1. If a higher quality of the artifact data set 21 is intended, then a plurality of selection lines are used.

In a second substep of substep S1, in this embodiment a transverse progression function is ascertained or adapted for each of the at least one selection lines. Here, the prior knowledge 20 plays a decisive role for the first time, as according to this, by considering previous measurements here, in particular the calibration measurements yet to be discussed, the transverse progression of the artifact 8 can best be described by a Gaussian function. Ultimately, the transverse progression along the selection line, which in the structureless region most likely ought to correspond to the progression 15 in FIG. 4, is fitted to a Gaussian function, meaning that it is parametrized, for example by indicating at least the amplitude and the width. The parameters determined in this manner therefore define the transverse progression function for the corresponding selection line. It should be noted that, in principle, other functional forms can also be used for the transverse progression function, for example half a sine cycle.

If other selection lines are considered, then boundary conditions from the prior knowledge 20 relating thereto can also be introduced, for example such that the width of the Gaussian function is to increase with increasing distance from the tip 6, and the amplitude is to fall.

In a third substep of step S1, in this embodiment, the results for the transverse progression function are used in order to determine the longitudinal progression function. Ideally, this also has a functional form already predefined by the prior knowledge 20, wherein in a simple case it is possible to make an assumption regarding the linearity, but preferably the result of a spline fit to calibration measurements is used. In calibration measurements, the metal object 1 is measured in a preferably structureless phantom, here a water phantom, with the same recording parameters. Due to the structureless nature of the water phantom, which replaces the object 3, it is possible to directly derive the progressions for the artifact 8, as the anticipated value for the attenuation value (HU value) of the water is also known. Here, via a plurality of measurements, it is preferably possible to form a statistical average and the functional form can be ascertained by a spline interpolation in the longitudinal direction for the parameters of the transverse progression functions, in particular therefore the amplitudes and the widths of the Gaussian functions, which of course can likewise be determined for the calibration measurements.

Starting from the predefined functional form for the metal object 1 or a metal object of the same type, as can be derived from the calibration measurements, it is now possible in the third substep of step S1 to adapt this functional form to the image data via corresponding parameters of the longitudinal progression function, comprising at least the artifact origin (where it is possible to start from the image value there as the amplitude and from a very small width) and a selection line (where the parameters are indeed present as a result of the second substep for ascertaining the transverse progression function). For a more precise determination, it is of course possible for a plurality of selection lines to be considered, in order to obtain further supporting points for the adapting of the functional form and thus the ascertaining of the longitudinal progression function.

Since the transverse progression function and the longitudinal progression function are known, in a fourth substep the artifact data set 21 can be determined in a simple manner, by calculating which attenuation value is present for the artifact for each pixel or voxel on the basis of the longitudinal and transverse progression function.

In this context, it should also be noted at this point that a main application area will be two-dimensional sectional images, cf. the exemplary schematic sectional image 7, thus two-dimensional computed tomography image data sets 19, but of course an extension to three-dimensional computed tomography image data sets 19 can readily take place, for example, by considering transverse progression functions for two directions that are perpendicular to one another and perpendicular to the longitudinal direction or by assuming symmetry (particularly if the metal object 1 itself has rotational symmetry).

In a second, preferred variant for ascertaining the artifact data set 21, it is also possible to use a database with reference data sets, which ideally has been ascertained and compiled for various reference metal objects and parameters of the reference metal objects. These may be based on reference measurements which, as in the case of the calibration measurements, ideally can be performed with a structureless phantom, here a water phantom, wherein ideally a plurality of measurements are performed for each combination of reference metal object and parameters, in order to achieve a statistical averaging that ideally renders the shape of the artifact 8 as a reference data set. If a metal object 1 that matches a reference data set in terms of type and parameters is then used, then the corresponding reference data set can also then be retrieved from the database as the artifact data set 21. An interpolation is also possible for intermediate parameters. Should recording parameters have an influence, these of course can likewise be taken into consideration accordingly when constructing the database or by way of a corresponding conversion of reference data sets.

In addition to the two preferred embodiments mentioned here, which are able to provide correction in real time, further conceivable embodiments also exist, for example which use a trained artificial intelligence ascertaining function, for example a neural network.

FIG. 7 shows a schematic outline of a computed tomography facility 23 according to an example embodiment of the present invention. As is known in principle, this comprises a gantry 24, in which a recording arrangement with an X-ray emitter 25 and an X-ray detector 26 is rotatably mounted. The gantry 24 has a central opening, into which a patient can be introduced by a patient table 27 in such a manner that the recording area is located in the field of view of the recording arrangement.

With regard to the performing of an intervention with the use of the metal object 1 as the intervention instrument, in particular the intervention needle 2, it is also possible for an actuating mechanism 28 for the in particular robotic movement of the metal object 1 to be arranged on the patient table 27, meaning that a person performing the intervention does not have to work directly in the gantry 24.

The operation of the computed tomography facility 23 is controlled via a control facility 29, which is embodied to perform the method according to an example embodiment of the present invention.

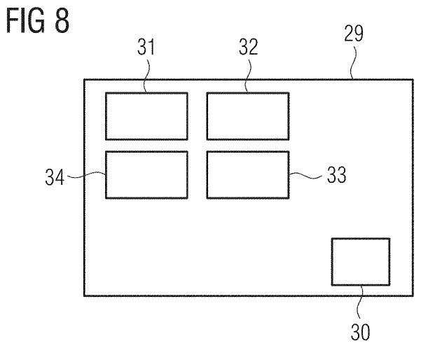

To this end, FIG. 8 shows the functional structure of the control facility 29 in further detail. This comprises a storage means and/or device 30, in which for example prior knowledge 20 can be stored, for example in the form of the functional forms of the transverse and longitudinal progression functions and/or in the form of the database described. A recording unit 31, which is known in principle, controls the recording operation and can forward recorded projection images to a reconstruction unit 32, which provides the reconstructed computed tomography image data set 19, in the present case to an ascertaining unit 33.

The ascertaining unit 33 ascertains, as described in step S1, the artifact data set 21, meaning that the reconstructed computed tomography image data set 19 can be corrected via a correction unit 34 by subtracting the artifact data set 21 in accordance with step S2. The corrected computed tomography image data set 22 produced in this way can then be stored, for example, output via an interface and/or represented via an output unit on a representation facility of the computed tomography facility 23.

It will be understood that, although the terms first, second, etc. may be used herein to describe various elements, components, regions, layers, and/or sections, these elements, components, regions, layers, and/or sections, should not be limited by these terms. These terms are only used to distinguish one element from another. For example, a first element could be termed a second element, and, similarly, a second element could be termed a first element, without departing from the scope of example embodiments. As used herein, the term “and/or,” includes any and all combinations of one or more of the associated listed items. The phrase “at least one of” has the same meaning as “and/or”.

Spatially relative terms, such as “beneath,” “below,” “lower,” “under,” “above,” “upper,” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below,” “beneath,” or “under,” other elements or features would then be oriented “above” the other elements or features. Thus, the example terms “below” and “under” may encompass both an orientation of above and below. The device may be otherwise oriented (rotated 90 degrees or at other orientations) and the spatially relative descriptors used herein interpreted accordingly. In addition, when an element is referred to as being “between” two elements, the element may be the only element between the two elements, or one or more other intervening elements may be present.

Spatial and functional relationships between elements (for example, between modules) are described using various terms, including “on,” “connected,” “engaged,” “interfaced,” and “coupled.” Unless explicitly described as being “direct,” when a relationship between first and second elements is described in the disclosure, that relationship encompasses a direct relationship where no other intervening elements are present between the first and second elements, and also an indirect relationship where one or more intervening elements are present (either spatially or functionally) between the first and second elements. In contrast, when an element is referred to as being “directly” on, connected, engaged, interfaced, or coupled to another element, there are no intervening elements present. Other words used to describe the relationship between elements should be interpreted in a like fashion (e.g., “between,” versus “directly between,” “adjacent,” versus “directly adjacent,” etc.).

The terminology used herein is for the purpose of describing particular embodiments only and is not intended to be limiting of example embodiments. As used herein, the singular forms “a,” “an,” and “the,” are intended to include the plural forms as well, unless the context clearly indicates otherwise. As used herein, the terms “and/or” and “at least one of” include any and all combinations of one or more of the associated listed items. It will be further understood that the terms “comprises,” “comprising,” “includes,” and/or “including,” when used herein, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. Expressions such as “at least one of,” when preceding a list of elements, modify the entire list of elements and do not modify the individual elements of the list. Also, the term “example” is intended to refer to an example or illustration.

It should also be noted that in some alternative implementations, the functions/acts noted may occur out of the order noted in the figures. For example, two figures shown in succession may in fact be executed substantially concurrently or may sometimes be executed in the reverse order, depending upon the functionality/acts involved.

Unless otherwise defined, all terms (including technical and scientific terms) used herein have the same meaning as commonly understood by one of ordinary skill in the art to which example embodiments belong. It will be further understood that terms, e.g., those defined in commonly used dictionaries, should be interpreted as having a meaning that is consistent with their meaning in the context of the relevant art and will not be interpreted in an idealized or overly formal sense unless expressly so defined herein.

It is noted that some example embodiments may be described with reference to acts and symbolic representations of operations (e.g., in the form of flow charts, flow diagrams, data flow diagrams, structure diagrams, block diagrams, etc.) that may be implemented in conjunction with units and/or devices discussed above. Although discussed in a particularly manner, a function or operation specified in a specific block may be performed differently from the flow specified in a flowchart, flow diagram, etc. For example, functions or operations illustrated as being performed serially in two consecutive blocks may actually be performed simultaneously, or in some cases be performed in reverse order. Although the flowcharts describe the operations as sequential processes, many of the operations may be performed in parallel, concurrently or simultaneously. In addition, the order of operations may be re-arranged. The processes may be terminated when their operations are completed, but may also have additional steps not included in the figure. The processes may correspond to methods, functions, procedures, subroutines, subprograms, etc.

Specific structural and functional details disclosed herein are merely representative for purposes of describing example embodiments. The present invention may, however, be embodied in many alternate forms and should not be construed as limited to only the embodiments set forth herein.

In addition, or alternative, to that discussed above, units and/or devices according to one or more example embodiments may be implemented using hardware, software, and/or a combination thereof. For example, hardware devices may be implemented using processing circuitry such as, but not limited to, a processor, Central Processing Unit (CPU), a controller, an arithmetic logic unit (ALU), a digital signal processor, a microcomputer, a field programmable gate array (FPGA), a System-on-Chip (SoC), a programmable logic unit, a microprocessor, or any other device capable of responding to and executing instructions in a defined manner. Portions of the example embodiments and corresponding detailed description may be presented in terms of software, or algorithms and symbolic representations of operation on data bits within a computer memory. These descriptions and representations are the ones by which those of ordinary skill in the art effectively convey the substance of their work to others of ordinary skill in the art. An algorithm, as the term is used here, and as it is used generally, is conceived to be a self-consistent sequence of steps leading to a desired result. The steps are those requiring physical manipulations of physical quantities. Usually, though not necessarily, these quantities take the form of optical, electrical, or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind that all of these and similar terms are to be associated with the appropriate physical quantities and are merely convenient labels applied to these quantities. Unless specifically stated otherwise, or as is apparent from the discussion, terms such as “processing” or “computing” or “calculating” or “determining” of “displaying” or the like, refer to the action and processes of a computer system, or similar electronic computing device/hardware, that manipulates and transforms data represented as physical, electronic quantities within the computer system's registers and memories into other data similarly represented as physical quantities within the computer system memories or registers or other such information storage, transmission or display devices.

In this application, including the definitions below, the term ‘module’ or the term ‘controller’ may be replaced with the term ‘circuit.’ The term ‘module’ may refer to, be part of, or include processor hardware (shared, dedicated, or group) that executes code and memory hardware (shared, dedicated, or group) that stores code executed by the processor hardware.

The module may include one or more interface circuits. In some examples, the interface circuits may include wired or wireless interfaces that are connected to a local area network (LAN), the Internet, a wide area network (WAN), or combinations thereof. The functionality of any given module of the present disclosure may be distributed among multiple modules that are connected via interface circuits. For example, multiple modules may allow load balancing. In a further example, a server (also known as remote, or cloud) module may accomplish some functionality on behalf of a client module.

Software may include a computer program, program code, instructions, or some combination thereof, for independently or collectively instructing or configuring a hardware device to operate as desired. The computer program and/or program code may include program or computer-readable instructions, software components, software modules, data files, data structures, and/or the like, capable of being implemented by one or more hardware devices, such as one or more of the hardware devices mentioned above. Examples of program code include both machine code produced by a compiler and higher level program code that is executed using an interpreter.

For example, when a hardware device is a computer processing device (e.g., a processor, Central Processing Unit (CPU), a controller, an arithmetic logic unit (ALU), a digital signal processor, a microcomputer, a microprocessor, etc.), the computer processing device may be configured to carry out program code by performing arithmetical, logical, and input/output operations, according to the program code. Once the program code is loaded into a computer processing device, the computer processing device may be programmed to perform the program code, thereby transforming the computer processing device into a special purpose computer processing device. In a more specific example, when the program code is loaded into a processor, the processor becomes programmed to perform the program code and operations corresponding thereto, thereby transforming the processor into a special purpose processor.

Software and/or data may be embodied permanently or temporarily in any type of machine, component, physical or virtual equipment, or computer storage medium or device, capable of providing instructions or data to, or being interpreted by, a hardware device. The software also may be distributed over network coupled computer systems so that the software is stored and executed in a distributed fashion. In particular, for example, software and data may be stored by one or more computer readable recording mediums, including the tangible or non-transitory computer-readable storage media discussed herein.

Even further, any of the disclosed methods may be embodied in the form of a program or software. The program or software may be stored on a non-transitory computer readable medium and is adapted to perform any one of the aforementioned methods when run on a computer device (a device including a processor). Thus, the non-transitory, tangible computer readable medium, is adapted to store information and is adapted to interact with a data processing facility or computer device to execute the program of any of the above mentioned embodiments and/or to perform the method of any of the above mentioned embodiments.

Example embodiments may be described with reference to acts and symbolic representations of operations (e.g., in the form of flow charts, flow diagrams, data flow diagrams, structure diagrams, block diagrams, etc.) that may be implemented in conjunction with units and/or devices discussed in more detail below. Although discussed in a particularly manner, a function or operation specified in a specific block may be performed differently from the flow specified in a flowchart, flow diagram, etc. For example, functions or operations illustrated as being performed serially in two consecutive blocks may actually be performed simultaneously, or in some cases be performed in reverse order.

According to one or more example embodiments, computer processing devices may be described as including various functional units that perform various operations and/or functions to increase the clarity of the description. However, computer processing devices are not intended to be limited to these functional units. For example, in one or more example embodiments, the various operations and/or functions of the functional units may be performed by other ones of the functional units. Further, the computer processing devices may perform the operations and/or functions of the various functional units without sub-dividing the operations and/or functions of the computer processing units into these various functional units.

Units and/or devices according to one or more example embodiments may also include one or more storage devices. The one or more storage devices may be tangible or non-transitory computer-readable storage media, such as random access memory (RAM), read only memory (ROM), a permanent mass storage device (such as a disk drive), solid state (e.g., NAND flash) device, and/or any other like data storage mechanism capable of storing and recording data. The one or more storage devices may be configured to store computer programs, program code, instructions, or some combination thereof, for one or more operating systems and/or for implementing the example embodiments described herein. The computer programs, program code, instructions, or some combination thereof, may also be loaded from a separate computer readable storage medium into the one or more storage devices and/or one or more computer processing devices using a drive mechanism. Such separate computer readable storage medium may include a Universal Serial Bus (USB) flash drive, a memory stick, a Blu-ray/DVD/CD-ROM drive, a memory card, and/or other like computer readable storage media. The computer programs, program code, instructions, or some combination thereof, may be loaded into the one or more storage devices and/or the one or more computer processing devices from a remote data storage device via a network interface, rather than via a local computer readable storage medium. Additionally, the computer programs, program code, instructions, or some combination thereof, may be loaded into the one or more storage devices and/or the one or more processors from a remote computing system that is configured to transfer and/or distribute the computer programs, program code, instructions, or some combination thereof, over a network. The remote computing system may transfer and/or distribute the computer programs, program code, instructions, or some combination thereof, via a wired interface, an air interface, and/or any other like medium.

The one or more hardware devices, the one or more storage devices, and/or the computer programs, program code, instructions, or some combination thereof, may be specially designed and constructed for the purposes of the example embodiments, or they may be known devices that are altered and/or modified for the purposes of example embodiments.

A hardware device, such as a computer processing device, may run an operating system (OS) and one or more software applications that run on the OS. The computer processing device also may access, store, manipulate, process, and create data in response to execution of the software. For simplicity, one or more example embodiments may be exemplified as a computer processing device or processor; however, one skilled in the art will appreciate that a hardware device may include multiple processing elements or processors and multiple types of processing elements or processors. For example, a hardware device may include multiple processors or a processor and a controller. In addition, other processing configurations are possible, such as parallel processors.

The computer programs include processor-executable instructions that are stored on at least one non-transitory computer-readable medium (memory). The computer programs may also include or rely on stored data. The computer programs may encompass a basic input/output system (BIOS) that interacts with hardware of the special purpose computer, device drivers that interact with particular devices of the special purpose computer, one or more operating systems, user applications, background services, background applications, etc. As such, the one or more processors may be configured to execute the processor executable instructions.

The computer programs may include: (i) descriptive text to be parsed, such as HTML (hypertext markup language) or XML (extensible markup language), (ii) assembly code, (iii) object code generated from source code by a compiler, (iv) source code for execution by an interpreter, (v) source code for compilation and execution by a just-in-time compiler, etc. As examples only, source code may be written using syntax from languages including C, C++, C #, Objective-C, Haskell, Go, SQL, R, Lisp, Java®, Fortran, Perl, Pascal, Curl, OCaml, Javascript®, HTML5, Ada, ASP (active server pages), PHP, Scala, Eiffel, Smalltalk, Erlang, Ruby, Flash®, Visual Basic®, Lua, and Python®.

Further, at least one example embodiment relates to the non-transitory computer-readable storage medium including electronically readable control information (processor executable instructions) stored thereon, configured in such that when the storage medium is used in a controller of a device, at least one embodiment of the method may be carried out.

The computer readable medium or storage medium may be a built-in medium installed inside a computer device main body or a removable medium arranged so that it can be separated from the computer device main body. The term computer-readable medium, as used herein, does not encompass transitory electrical or electromagnetic signals propagating through a medium (such as on a carrier wave); the term computer-readable medium is therefore considered tangible and non-transitory. Non-limiting examples of the non-transitory computer-readable medium include, but are not limited to, rewriteable non-volatile memory devices (including, for example flash memory devices, erasable programmable read-only memory devices, or a mask read-only memory devices); volatile memory devices (including, for example static random access memory devices or a dynamic random access memory devices); magnetic storage media (including, for example an analog or digital magnetic tape or a hard disk drive); and optical storage media (including, for example a CD, a DVD, or a Blu-ray Disc). Examples of the media with a built-in rewriteable non-volatile memory, include but are not limited to memory cards; and media with a built-in ROM, including but not limited to ROM cassettes; etc. Furthermore, various information regarding stored images, for example, property information, may be stored in any other form, or it may be provided in other ways.

The term code, as used above, may include software, firmware, and/or microcode, and may refer to programs, routines, functions, classes, data structures, and/or objects. Shared processor hardware encompasses a single microprocessor that executes some or all code from multiple modules. Group processor hardware encompasses a microprocessor that, in combination with additional microprocessors, executes some or all code from one or more modules. References to multiple microprocessors encompass multiple microprocessors on discrete dies, multiple microprocessors on a single die, multiple cores of a single microprocessor, multiple threads of a single microprocessor, or a combination of the above.

Shared memory hardware encompasses a single memory device that stores some or all code from multiple modules. Group memory hardware encompasses a memory device that, in combination with other memory devices, stores some or all code from one or more modules.

The term memory hardware is a subset of the term computer-readable medium. The term computer-readable medium, as used herein, does not encompass transitory electrical or electromagnetic signals propagating through a medium (such as on a carrier wave); the term computer-readable medium is therefore considered tangible and non-transitory. Non-limiting examples of the non-transitory computer-readable medium include, but are not limited to, rewriteable non-volatile memory devices (including, for example flash memory devices, erasable programmable read-only memory devices, or a mask read-only memory devices); volatile memory devices (including, for example static random access memory devices or a dynamic random access memory devices); magnetic storage media (including, for example an analog or digital magnetic tape or a hard disk drive); and optical storage media (including, for example a CD, a DVD, or a Blu-ray Disc). Examples of the media with a built-in rewriteable non-volatile memory, include but are not limited to memory cards; and media with a built-in ROM, including but not limited to ROM cassettes; etc. Furthermore, various information regarding stored images, for example, property information, may be stored in any other form, or it may be provided in other ways.

The apparatuses and methods described in this application may be partially or fully implemented by a special purpose computer created by configuring a general purpose computer to execute one or more particular functions embodied in computer programs. The functional blocks and flowchart elements described above serve as software specifications, which can be translated into the computer programs by the routine work of a skilled technician or programmer.

Although described with reference to specific examples and drawings, modifications, additions and substitutions of example embodiments may be variously made according to the description by those of ordinary skill in the art. For example, the described techniques may be performed in an order different with that of the methods described, and/or components such as the described system, architecture, devices, circuit, and the like, may be connected or combined to be different from the above-described methods, or results may be appropriately achieved by other components or equivalents.

Although the present invention has been illustrated and described in detail by way of the preferred exemplary embodiment, the present invention is not restricted by the examples disclosed and other variations can be derived therefrom by a person skilled in the art without departing from the protective scope of the present invention.

What is claimed is:

1. A method for correcting artifacts in a computed tomography image data set of a recording region in which an at least substantially needle-shaped metal object is located, wherein the computed tomography image data set is reconstructed from projection images recorded at least partially such that the at least substantially needle-shaped metal object is irradiated at least substantially in a longitudinal direction, and wherein the method comprises:
ascertaining an artifact data set describing, in an image space, at least one artifact caused by the at least substantially needle-shaped metal object, wherein the ascertaining is based on prior knowledge about the at least one artifact; and
subtracting the artifact data set from the computed tomography image data set.

2. The method as claimed in claim 1, wherein during intervention monitoring with the at least substantially needle-shaped metal object as an intervention instrument, at least one of
correction takes place for each recorded computed tomography image data set of a monitoring series,
an image plane of the computed tomography image data set is a longitudinal extension plane of the at least substantially needle-shaped metal object, or
the at least substantially needle-shaped metal object is an intervention needle.

3. The method as claimed in claim 1, wherein the ascertaining ascertains the artifact data set at least partially by at least one of ascertaining or adapting at least one progression function describing a progression of the at least one artifact that starts from a tip of the at least substantially needle-shaped metal object in at least one direction in the image space, the at least one of ascertaining or adapting based on image data, lying in an artifact region, of the computed tomography image data set.

4. The method as claimed in claim 3, wherein at least one of the at least one progression function is a transverse progression function perpendicular to the longitudinal direction of the at least substantially needle-shaped metal object in a longitudinal extension plane of the at least substantially needle-shaped metal object, and wherein the image data is chosen along at least one selection line that progresses at least substantially perpendicularly to the longitudinal direction of the at least substantially needle-shaped metal object.

5. The method as claimed in claim 4, wherein the transverse progression function is a Gaussian function.

6. The method as claimed in claim 4, wherein a longitudinal progression function along the longitudinal direction of the at least substantially needle-shaped metal object is used as a further progression function, and wherein the longitudinal progression function describes at least one parameter of a functional form chosen as the transverse progression function along the longitudinal direction.

7. The method as claimed in claim 6, wherein, for at least one of the ascertaining or adapting of the longitudinal progression function, image data of at least one image point of the at least one artifact is chosen in the computed tomography image data set, wherein the at least one image point lies adjacent to the tip of the at least substantially needle-shaped metal object as an artifact origin.

8. The method as claimed in claim 6, wherein a functional form of the longitudinal progression function to be at least one of adapted or ascertained is chosen from the prior knowledge about the at least one artifact, which is specific to the at least substantially needle-shaped metal object.

9. The method as claimed in claim 8, wherein, to ascertain the prior knowledge, at least one of analytical calculations of the at least one artifact or calibration measurements of at least one of the at least substantially needle-shaped metal object or a metal object of a same type are performed in a phantom.

10. The method as claimed in claim 1, wherein the ascertaining of the artifact data set comprises:
at least one of choosing or determining, at least partially from reference data sets present in a database, the artifact data set for at least one of various reference metal objects or various parameters of at least one of the at least substantially needle-shaped metal object or the various reference metal objects.

11. The method as claimed in claim 10, wherein the reference data sets are derived from learning measurements of at least one of the at least substantially needle-shaped metal object or at least one reference metal object of a same type in a phantom.

12. The method as claimed in claim 10, wherein at least part of the ascertaining of the artifact data set is performed via the database based on recording parameters that deviate with regard to the reference data sets.

13. A computed tomography device including a control device configured to perform the method as claimed in claim 1.

14. A non-transitory computer-readable medium storing computer-executable instructions that, when executed at a control device of a computed tomography device, cause the computed tomography device to perform the method of claim 1.

15. A computed tomography device comprising:
a memory storing computer-executable instructions; and
at least one processor configured to executed the computer-executable instructions to cause the computed tomography device to
ascertain an artifact data set describing, in an image space, at least one artifact caused by an at least substantially needle-shaped metal object, wherein the artifact data set is ascertained based on prior knowledge about the at least one artifact, and
subtract the artifact data set from a computed tomography image data set of a recording region in which the at least substantially needle-shaped metal object is located, to correct for artifacts in the computed tomography image data set, wherein
the computed tomography image data set is reconstructed from projection images recorded at least partially such that the at least substantially needle-shaped metal object is irradiated at least substantially in a longitudinal direction.

16. The method as claimed in claim 4, wherein the longitudinal extension plane corresponds to an image plane of the computed tomography image data set.

17. The method as claimed in claim 9, wherein the phantom is a structureless phantom.

18. The method as claimed in claim 17, wherein the structureless phantom is a water phantom.

19. The method as claimed in claim 11, wherein the phantom is a structureless phantom.

20. The method as claimed in claim 19, wherein the structureless phantom is a water phantom.

21. The method as claimed in claim 5, wherein a longitudinal progression function along the longitudinal direction of the at least substantially needle-shaped metal object is used as a further progression function, and wherein the longitudinal progression function describes at least one parameter of a functional form chosen as the transverse progression function along the longitudinal direction.

22. The method as claimed in claim 7, wherein a functional form of the longitudinal progression function to be at least one of adapted or ascertained is chosen from the prior knowledge about the at least one artifact, which is specific to the at least substantially needle-shaped metal object.

23. The method as claimed in claim 22, wherein the ascertaining of the artifact data set comprises:
at least one of choosing or determining, at least partially from reference data sets present in a database, the artifact data set for at least one of various reference metal objects or various parameters of at least one of the at least substantially needle-shaped metal object or the various reference metal objects.

24. The method as claimed in claim 8, wherein the ascertaining of the artifact data set comprises:
at least one of choosing or determining, at least partially from reference data sets present in a database, the artifact data set for at least one of various reference metal objects or various parameters of at least one of the at least substantially needle-shaped metal object or the various reference metal objects.

25. The method as claimed in claim 11, wherein at least part of the ascertaining of the artifact data set is performed via the database based on recording parameters that deviate with regard to the reference data sets.
